(19) United States
(12) Patent Application Publication
(10) Pub. No.: US 2020/0372511 A1
(43) Pub. Date: Nov. 26, 2020

(54) Information Reminding Method and Apparatus, and Electronic Device

(71) Applicant: Beijing Kingsoft Internet Security Software Co., Ltd., Beijing (CN)

(72) Inventor: Kangzong ZHANG, Beijing (CN)

(21) Appl. No.: 16/957,003

(22) PCT Filed: Oct. 8, 2018
(86) PCT No.: PCT/CN2018/109288

§ 371 Date: Jun. 22, 2020

(30) Foreign Application Priority Data
Feb. 12, 2018 (CN) 201810146799.3

(51) Int. Cl. G06Q 20/40; H04L 9/06

(52) U.S. Cl. CPC G06Q 20/4093; H04L 9/0637; H04L 2209/56; G06Q 2220/00; H04L 2209/38; G06Q 20/4016

(57) ABSTRACT

The embodiments of the present application provide a method and apparatus for information and an electronic device. The method includes: when it is detected that a transaction record for a target account is generated in a blockchain ledger, obtaining the generated transaction record for the target account as a current transaction record; comparing the current transaction record with a locally stored transaction record(s) for the target account; when it is determined that the current transaction record differs from any one of the locally stored transaction records for the target account, determining that a security risk of the target account exists; and outputting alert information to alert a user of the target account that the security risk of the target account exists. In this way, the legitimacy of the asset transaction is identified, and thus the security of the account is identified.

The present application claims the priority to a Chinese Patent Application No. 201810146799.3, filed with the China National Intellectual Property Administration on Feb. 12, 2018 and entitled “METHOD AND APPARATUS FOR INFORMATION REMINDING AND ELECTRONIC DEVICE”, which is incorporated herein by reference in its entirety.

### TECHNICAL FIELD

The present application relates to the technical field of information security, and in particular, to a method and apparatus for information reminding and an electronic device.

### BACKGROUND

With the popularity of smart terminals, for the sake of convenience, people are more and more inclined to use digital wallets to manage their own assets. In an existing digital wallet, a user may create an account in the digital wallet, and control his own assets based on the account, such as, transfer, payment, and receipt.

In the existing digital wallet, when an asset transaction is performed for an account of a user, the digital wallet can output asset transaction information only based on the asset transaction for presenting the asset transaction for the account to the user.

However, the existing digital wallet cannot identify whether the asset transaction is legal, that is, whether the asset transaction is performed by the user himself.

### SUMMARY

The object of the embodiments of the present application is to provide a method and apparatus for information reminding and an electronic device, so as to identify the legitimacy of the asset transaction, and thus identify the security of the account. Specifically, the technical solutions are as follows.

In one aspect, an embodiment of the present application provides a method for information reminding including:

when it is detected that a transaction record for a target account is generated in a blockchain ledger, obtaining the generated transaction record for the target account as a current transaction record;

comparing the current transaction record with a locally stored transaction record(s) for the target account;

when it is determined that the current transaction record differs from any one of the locally stored transaction records for the target account, determining that a security risk of the target account exists; and

outputting alert information to alert a user of the target account that the security risk of the target account exists.

Optionally, the method further includes:

when it is determined that the current transaction record is the same as one of the locally stored transaction records for the target account, determining that the target account is safe; and

outputting the current transaction record to remind the user that a transaction was conducted on the target account.

Optionally, the method further includes:

periodically or non-periodically obtaining transaction records for the target account from the blockchain ledger; and

outputting the obtained transaction records for the target account to enable the user to view the transaction records for the target account and perform account reconciliation.

Optionally, after outputting the alert information, the method further includes:

outputting prompt information to prompt the user to change an account.

Optionally, outputting alert information includes:

outputting the alert information in a popup window.

Optionally, before outputting the alert information, the method further includes:

obtaining a communication identifier for the user pre-bound to the target account;

the step of outputting alert information includes:

based on the obtained communication identifier for the user, outputting the alert information.

Optionally, the communication identifier includes a telephone number and/or an email address.

In another aspect, an embodiment of the present application provides an apparatus for information reminding, including:

a first obtaining module configured for when it is detected that a transaction record for a target account is generated in a blockchain ledger, obtaining the generated transaction record for the target account as a current transaction record;

a comparing module configured for comparing the current transaction record with a locally stored transaction record(s) for the target account;

a first determining module configured for when the current transaction record differs from any one of the locally stored transaction records for the target account, determining that a security risk of the target account exists; and

a first outputting module configured for outputting alert information to alert a user of the target account that the security risk of the target account exists.

Optionally, the apparatus further includes a second determining module and a second outputting module.

The second determining module is configured for when the current transaction record is the same as one of the locally stored transaction records for the target account, determining that the target account is safe.

The second outputting module is configured for outputting the current transaction record to remind the user that a transaction was conducted on the target account.

Optionally, the apparatus further includes a second obtaining module and a third outputting module.

The second obtaining module is configured for periodically or non-periodically obtaining transaction records for the target account from the blockchain ledger.

The third outputting module is configured for outputting the obtained transaction records for the target account to enable the user to view the transaction records for the target account and perform account reconciliation.

Optionally, the apparatus further includes a fourth outputting module.

The fourth outputting module is configured for outputting prompt information to prompt the user to change an account.

Optionally, the first outputting module is specifically configured for:

outputting the alert information in a popup window.

Optionally, the apparatus further includes a third obtaining module.

The third obtaining module is configured for obtaining a communication identifier for the user pre-bound to the target account before the alert information is output.

The first outputting module is configured for based on the obtained communication identifier for the user, outputting the alert information.

Optionally, the communication identifier includes a telephone number and/or an email address.

In another aspect, an embodiment of the present application provides an electronic device including a processor, a communication interface, a memory and a communication bus, wherein the processor, the communication interface and the memory communicate with each other via the communication bus;

the memory is configured for storing a computer program;

the processor is configured for performing any one of the methods for information reminding according to the embodiments of the present application when executing the computer program stored on the memory.

In another aspect, an embodiment of the present application provides a computer-readable storage medium for storing a computer program thereon, wherein the computer program is executed by a processor to cause the processor to perform any one of the methods for information reminding according to according to the embodiments of the present application.

In another aspect, an embodiment of the present application provides a computer program product which is run on a computer so as to the computer to perform any one of the methods for information reminding according to according to the embodiments of the present application.

In the embodiment of the present application, when it is detected that a transaction record for a target account is generated in a blockchain ledger, the generated transaction record for the target account is obtained as a current transaction record; the current transaction record is compared with a locally stored transaction record(s) for the target account; when it is determined that the current transaction record differs from any one of the locally stored transaction records for the target account, it is determined that a security risk of the target account exists; alert information is output to alert a user of the target account that the security risk of the target account exists.

In the embodiment of the present application, whether a transaction on the target account is a legal transaction may be determined by comparing a record of this transaction on the target account in the blockchain ledger with the locally stored transaction records for the target account, and then whether a security risk of the target account exists may be determined. When the current transaction record differs from any one of the locally stored transaction records for the target account, it may be determined that the security risk of the target account exists, and alert information is output to alert a user of the target account that the security risk of the target account exists, which identifies the security of the account. It should be understood that any product or method for implementing the embodiments of the present disclosure does not necessarily require all of the advantages described above.

### BRIEF DESCRIPTION OF THE DRAWINGS

In order to more clearly describe the technical solution of the embodiments of the application or of the prior art, drawings needed in the embodiments and the prior art will be briefly described below. Obviously, the drawings described below are for only some embodiments of the present application; one of ordinary skills in the art may also obtain other drawings based on these drawings without any creative efforts.

FIG. 1 is a flowchart of an information reminding method according to an embodiment of the present application;

FIG. 2 is another flowchart of an information reminding method according to an embodiment of the present application;

FIG. 3 is a structural schematic diagram of an information reminding apparatus according to an embodiment of the present application;

FIG. 4 is another structural schematic diagram of an information reminding apparatus according to an embodiment of the present application;

FIG. 5 is a structural diagram of an electronic device according to an embodiment of the present application.

### DETAILED DESCRIPTION

The technical solution of the application will be described in detail with reference to the drawings of embodiments of the present application. Obviously, the embodiments described herein are only some, not all, of the embodiments of the present application. All other embodiments obtained by those of ordinary skills in the art based on the embodiments herein without any creative efforts are within the scope of the present application.

The object of the embodiments of the present application is to provide a method and apparatus for information reminding and an electronic device, so as to identify the legitimacy of an asset transaction, and then identify the security of the account.

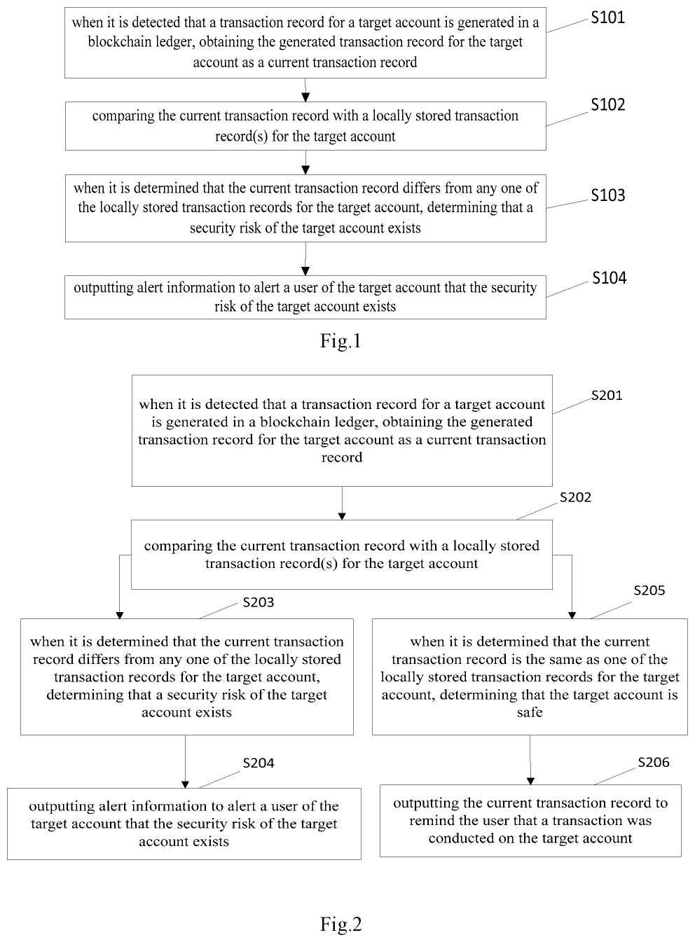

As shown in FIG. 1, there is provided a method for information reminding according to an embodiment of the present application, which includes the following steps.

S101, when it is detected that a transaction record for a target account is generated in a blockchain ledger, obtaining the generated transaction record for the target account as a current transaction record.

It should be understood that the method for information reminding according to the embodiment of the present application may be applied to any electronic device, such as smart phone, computer and console, etc. In an implementation, a functioning software to implement the method for information reminding according to the embodiment of the present application may be a specific client software, such as a digital wallet, or any plugin for a client software that can perform asset transaction and currency payment, such as a shopping client software, and so on. These are all reasonable. The functioning software is installed in the electronic device.

An electronic device may monitor a blockchain ledger in real-time, and detect whether a new transaction record is generated in the blockchain ledger. When detecting that a new transaction record is generated, the electronic device determines whether the new transaction record is a new transaction record for a target account. When determining that the new transaction record is a new transaction record for the target account, that is, detecting that a transaction record for the target account is generated in the blockchain ledger, the electronic device obtains the generated transaction record for the target account as the current transaction record and performs an information reminding process according to the embodiments of the present application.

Determining whether the new transaction record is the transaction record for the target account may include: determining whether the new transaction record contains an account address of the target account; and when it is determined that the new transaction record contains the account address of the target account, determining that the new transaction record is a transaction record for the target account; or determining whether an account address of an asset transaction initiator contained in the new transaction record is an account address of the target account; and when it is determined that the account address of the asset transaction initiator contained in the new transaction record is the account address of the target account, determining that the new transaction record is a transaction record for the target account. In the case that a correspondence between an account address of an asset transaction initiator and an account address of an asset transaction receiver is recorded in the transaction record, and a position of the account address of the asset transaction initiator is farther forward than a position of the account address of the asset transaction receiver in the transaction record, it is possible to determine whether the account address having a farther forward position in the transaction record is the account address of the target account, when the account address is the account address of the target account, it is determined that the new transaction record is a transaction record for the target account.

The target account may be an account with which a user is logged into the electronic device. When the functioning software to implement the method for information reminding according to the embodiment of the present application is a digital wallet, the target account is an account with which a user is logged into the digital wallet. When the functioning software to implement the method for information reminding according to the embodiment of the present application is any plugin in the client software that can perform asset transaction and currency payment, the target account is an account with which a user is logged into the client software.

In one case, each account corresponds to a private key. The private key is a unique credential for allocating assets in the account. Each private key corresponds to an account address. A user having the private key may have the privilege to allocate assets in the account.

When an asset transaction is conducted on the account, an asset transaction record, that is, a transaction record will be generated in the blockchain ledger. Meanwhile, a device into which a user is logged with the account, will generate and store an asset transaction record. The transaction record records a correspondence between an account address of the account and an account address of the asset transaction receiver corresponding to the asset transaction, and an asset balance of the account. For example, when a transaction is conducted on an account A, for example, money is transferred from the account A to an account B, a transaction record is generated in the blockchain ledger. The transaction record may include: the account address of the account A-the account address of the account B, and the balance a of the account A. The account address of the account A-the account address of the account B represents the correspondence between the account address of the account A and the account address of the account B. In one case, generation time for each transaction record is also recorded in the blockchain ledger, and a transaction amount of each transaction record may also be stored in the blockchain ledger.

The transaction records for asset transactions of all accounts are stored in the blockchain ledger, and all transaction records stored in the blockchain ledger are public to all accounts. In an embodiment of the present application, the asset may be digital currency, such as Bitcoin and Ethereum.

S102: comparing the current transaction record with a locally stored transaction record(s) for the target account;

In this step, after obtaining the current transaction record, the electronic device compares the current transaction with locally stored transaction records for the target account one by one to determine whether the current transaction record exists in the locally stored transaction records for the target account, and then perform information reminding process according to the determination result. In a case, to better save comparison time, the comparison may be performed in the inverse order of generation time of the locally stored transaction records. The current transaction record first is compared with a locally stored transaction record which is latest generated, and when the current transaction record differs from this latest generated transaction record, the comparison is continued until the current transaction record is completely compared with all of the locally stored transaction records. Alternatively, if the comparison this time is not the first comparison, in order to compare the current transaction record with the locally stored transaction records for the target account, the current transaction record may be only compared with a transaction record after a transaction record that has been already used in a preceding comparison of the comparison this time, in the inverse order of generation time of the locally stored transaction records.

The term “locally” is referred to the electronic device itself.

S103: when it is determined the current transaction record differs from any one of the locally stored transaction records for the target account, determining a security risk of the target account exists.

It will be understood that when the current transaction record doesn't exist in the locally stored transaction records for the target account, it is determined that the current transaction record is not a transaction conducted on the target account by a user logged into the electronic device with the target account, which indicates that the target account is not safe, that is, an security risk exists, for example, the private key corresponding to the target account is stolen. It will be understood that when the current transaction record exits in the locally stored transaction records for the target account, it is determined that the current transaction record is a transaction conducted on the target account by a user logged into the electronic device, which indicates that the target account is safe, this is, an security risk doesn't exist, and the private key corresponding to the target account isn't stolen.

S104: outputting alert information to alert a user of the target account that a security risk of the target account exists.

In an embodiment of the present application, when determining that the security risk of the target account exists, the electronic device outputs alert information to alert a user of the target account that the security risk of the target account exists, so that the user perform operations for protecting the target account, to better ensure the security of a user's asset.

In an implementation, the alert information may be output in voice prompt, in screen brightness prompt, in text information prompt, in page skip prompt, and so on. The form of the prompt of the alert information is not limited thereto.

In the embodiment of the present application, whether a transaction on the target account is a legal transaction may be determined by comparing a record of this transaction on the target account in the blockchain ledger with the locally stored transaction records for the target account, and then whether a security risk of the target account exists may be determined. When the current transaction record differs from any one of the locally stored transaction records for the target account, it may be determined that the security risk of the target account exists, and alert information is output to alert a user of the target account that the security risk of the target account exists, which identifies the security of the account.

In an implementation, as shown in FIG. 2, the method may include the following steps.

S201: when it is detected a transaction record for a target account is generated in a blockchain ledger, obtaining the generated transaction record for the target account as a current transaction record.

S202: comparing the current transaction record with locally stored transaction records for the target account.

S203: when the current transaction record differs from any one of the locally stored transaction records for the target account, determining that a security risk of the target account exists.

S204: outputting alert information to alert a user of the target account that the security risk of the target account exists.

S201-S204 are the same as S101-S104 shown in FIG. 1, respectively.

S205: when it is determined that the current transaction record is the same as one of the locally stored transaction records for the target account, determining that the target account is safe.

S206: outputting the current transaction record to remind the user that a transaction was conducted on the target account.

To better improve user experience, when determining that the target account is safe, the electronic device may output the current transaction record for reminding the user that the transaction was conducted on the target account, as an evidence for an asset transaction for the user.

In a case, in outputting the current transaction record, the electronic device first obtains a communication identifier for the user bound to the target account, and then outputs the current transaction record based on the obtained communication identifier. Specifically, the communication identifier may be an email address. At this time, the electronic device may send the current transaction record to the email address. The communication identifier may be a telephone number. At this time, the electronic device may send a text message with the current transaction to a phone corresponding to the telephone number, or call the telephone number to inform the user of the current transaction.

In another implementation, to better improve the user experience, the method may further include:

periodically or non-periodically obtaining transaction records for the target account from the blockchain ledger; and

outputting the obtained transaction records for the target account to enable the user to view the transaction records for the target account and perform account reconciliation.

It will be understood that the electronic device may monitor the blockchain ledger in real-time. The electronic device may preset cycles. During each cycle, the electronic device obtains the transaction records for the target account from the blockchain ledger, and outputs the transaction records for the target account to the user, so as to enable the user to view the transaction records for the target account and perform account reconciliation. Alternatively, each time when the electronic device obtains a command for acquiring the bill sent by the user, the electronic device obtains the transaction records for the target account from the blockchain ledger in response to the command, and outputs the transaction records for the target account to the user, so as to enable the user to view the transaction records for the target account and perform account reconciliation.

In an implementation, after outputting the alert information, the method may further include:

outputting prompt information to prompt the user to change an account.

In an embodiment of the present application, to better ensure the security of the user's asset, when it is determined that the security risk of the target account exists, that is, the security risk of the source in the target account exists, and after the alert information is output, the prompt information may be further output to the user to prompt the user to change an account. The prompt information may contain information about preset operations for guiding the user to change an account, so as to enable the user to create a new account (that is, a new private key corresponding to the new account) based on the guidance by the electronic device, that is, the information about preset operations. The user is logged into the new account number by the new private key, and transfers the asset from the target account to the new account, so as to achieve the changing of the account. To some extent, the user's asset is protected.

In an implementation, the alert information may be output in text prompt. At this time, the alert information may be output in a popup window. The popup window may include: information for alerting a user for the target account that a security risk of the target account exists. Alternatively, the alert information may be output by a GCM (Google Cloud Messaging) Push, which is cloud push messaging service. Specifically, outputting alert information may include:

outputting alert information in a popup window.

In an implementation, the alert information may be output in various ways. To better draw a user's attention, before outputting alert information, the method may further include:

obtaining a communication identifier for the user previously bound to the target account.

The step of outputting alert information may include:

based on the obtained communication identifier for the user, outputting the alert information.

In an embodiment of the present application, the electronic device may obtain the communication identifier for the user previously bound to the target account, and output the alert information based on the obtained communication identifier for the user. That is, the electronic device may determine a communication tool of the user based on the communication identifier. The communication tool may be communication software and/or a communication device. The alert information is output to the communication tool. In an implementation, the communication identifier may include a telephone number and/or an email address. In the case that the communication identifier is an email address, the communication tool may be a mailbox. At this time, the electronic device may send the alert information to the email address. In the case that the communication identifier is a telephone number, the electronic device may send the alert information in the form of message to a phone corresponding to the telephone number, or call the telephone number to inform the user of the alert information.

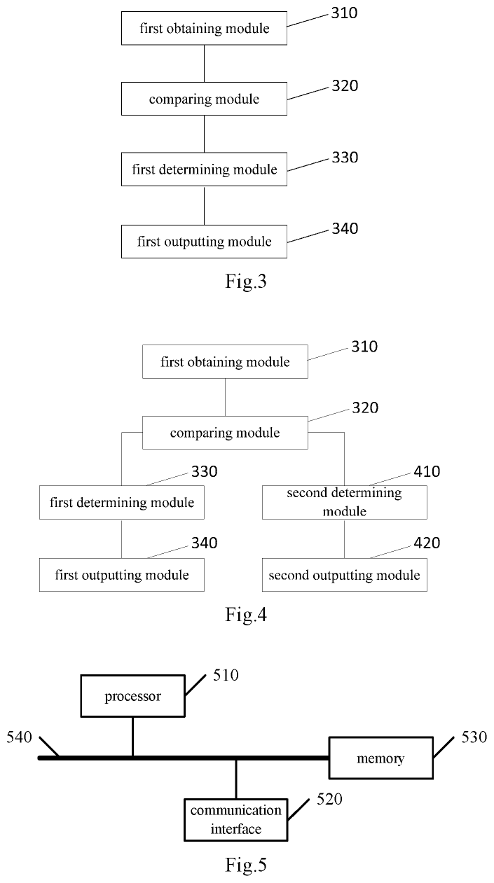

Corresponding to the embodiment of the method, an embodiment of the present application provides an apparatus for information reminding, as shown in FIG. 3. The apparatus may include:

a first obtaining module 310, configured for when it is detected that a transaction record for a target account is generated in a blockchain ledger, obtaining the generated transaction record for the target account as a current transaction record;

a comparing module 320, configured for comparing the current transaction record with a locally stored transaction record(s) for the target account;

a first determining module 330, configured for when the current transaction record differs from any one of the locally stored transaction records for the target account, determining that a security risk of the target account exists; and

a first outputting module 340, configured for outputting alert information to alert a user of the target account that the security risk of the target account exists.

In an embodiment of the present application, whether a transaction on the target account is a legal transaction may be determined by comparing a record of this transaction on the target account in the blockchain ledger with the locally stored transaction records for the target account, and then whether a security risk of the target account exists may be determined. When the current transaction record differs from any one of the locally stored transaction records for the target account, it may be determined that the security risk of the target account exists, and alert information is output to alert a user of the target account that the security risk of the target account exists, which identifies the security of the account.

In an implementation, as shown in FIG. 4, the apparatus may further include: a second determining module 410 and a second outputting module 420.

The second determining module 410 is configured for when the current transaction record is the same as one of the locally stored transaction records for the target account, determining that the target account is safe.

The outputting module 420 is configured for outputting the current transaction record to remind the user that a transaction was conducted on the target account.

In an implementation, the apparatus further includes a second obtaining module and a third outputting module.

The second obtaining module is configured for periodically or non-periodically obtaining transaction records for the target account from the blockchain ledger.

The third outputting module is configured for outputting the obtained transaction records for the target account to enable the user to view the transaction records for the target account and perform account reconciliation.

In an implementation, the apparatus further includes a fourth outputting module.

The fourth outputting module is configured for outputting prompt information to prompt the user to change an account.

In an implementation, the first outputting module 340 is specifically configured for: outputting the alert information in a popup window.

In an implementation, the apparatus further includes a third obtaining module.

The third obtaining module is configured for:

obtaining a communication identifier for the user pre-bound to the target account before the alert information is output.

The first outputting module 340 is configured for based on the obtained communication identifier for the user, outputting the alert information.

In an implementation, the communication identifier includes a telephone number and/or an email address.

Corresponding to the embodiment of the method, an embodiment of the present application provides an electronic device, as shown in FIG. 5, including a processor 510, a communication interface 520, a memory 530 and a communication bus 540. The processor 510, the communication interface 520, and the memory 530 communicate with each other via the communication bus 540.

The memory 530 stores a computer program thereon.

The processor 510, when executing the computer program stored on the memory 530, performs the method for information reminding according to the embodiment of the present application, including:

when it is detected that a transaction record for a target account is generated in a blockchain ledger, obtaining the generated transaction record for the target account as a current transaction record;

comparing the current transaction record with a locally stored transaction record(s) for the target account;

when it is determined that the current transaction record differs from any one of the locally stored transaction records for the target account, determining that a security risk of the target account exists; and

outputting alert information to alert a user of the target account that the security risk of the target account exists.

In an embodiment of the present application, whether a transaction on the target account is a legal transaction may be determined by comparing a record of this transaction on the target account in the blockchain ledger with the locally stored transaction records for the target account, and then whether a security risk of the target account exists may be determined. When the current transaction record differs from any one of the locally stored transaction records for the target account, it may be determined that the security risk of the target account exists, and alert information is output to alert a user of the target account that the security risk of the target account exists, which identifies the security of the account.

In an implementation, the method further includes:

when it is determined that the current transaction record is the same as one of the locally stored transaction records for the target account, determining that the target account is safe; and

outputting the current transaction record to remind the user that a transaction was conducted on the target account.

In an implementation, the method further includes:

periodically or non-periodically obtaining transaction records for the target account from the blockchain ledger; and

outputting the obtained transaction records for the target account to enable the user to view the transaction records for the target account and perform account reconciliation.

In an implementation, after outputting the alert information, the method further includes:

outputting prompt information to prompt the user to change an account.

In an implementation, outputting alert information includes:

outputting the alert information in a popup window.

In an implementation, before outputting the alert information, the method further includes:

obtaining a communication identifier for the user pre-bound to the target account;

the step of outputting alert information includes:

based on the obtained communication identifier for the user, outputting the alert information.

In an implementation, the communication identifier includes a telephone number and/or an email address.

The communication bus in the electronic device may be a Peripheral Component Interconnect (PCI) bus or an Extended Industry Standard Architecture (EISA) bus and the like. The communication bus may include an address bus, a data bus, a control bus, or the like. For representation, only one thick line is shown in the figure, which does not mean there is only one communication bus or one type of communication bus.

The communications interface is used for communication between the electronic device and other devices.

The memory may include a random access memory (RAM), or may include a non-volatile memory (NVM), for example at least one disk memory. Optionally, the memory may also be at least one storage device located away from the processor.

The processor may be a general-purpose processor, such as a central processing unit (CPU), a network processor (NP), or the like. The processor may also be a digital signal processor (DSP), an application specific integrated circuit (ASIC), a field-programmable gate array (FPGA) or other programmable logic devices, discrete gate or transistor logic devices, discrete hardware components.

Corresponding to the embodiment of the method, an embodiment of the present application provides a computer-readable storage medium. The computer-readable storage medium stores a computer program thereon, and the computer program is executed by a processor to cause the processor to perform the method for information reminding according to the embodiment of the present application, including:

when it is detected that a transaction record for a target account is generated in a blockchain ledger, obtaining the generated transaction record for the target account as a current transaction record;

comparing the current transaction record with a locally stored transaction record(s) for the target account;

when it is determined that the current transaction record differs from any one of the locally stored transaction records for the target account, determining that a security risk of the target account exists; and

outputting alert information to alert a user of the target account that the security risk of the target account exists.

In the embodiment of the present application, whether a transaction on the target account is a legal transaction may be determined by comparing a record of this transaction on the target account in the blockchain ledger with the locally stored transaction records for the target account, and then whether a security risk of the target account exists may be determined. When the current transaction record differs from any one of the locally stored transaction records for the target account, it may be determined that the security risk of the target account exists, and alert information is output to alert a user of the target account that the security risk of the target account exists, which identifies the security of the account.

In an implementation, the method further includes:

when it is determined that the current transaction record is the same as one of the locally stored transaction records for the target account, determining that the target account is safe; and

outputting the current transaction record to remind the user that a transaction was conducted on the target account.

In an implementation, the method further includes:

periodically or non-periodically obtaining transaction records for the target account from the blockchain ledger; and

outputting the obtained transaction records for the target account to enable the user to view the transaction records for the target account and perform account reconciliation.

In an implementation, after outputting the alert information, the method further includes:

outputting prompt information to prompt the user to change an account.

In an implementation, outputting alert information includes:

outputting the alert information in a popup window.

In an implementation, before outputting the alert information, the method further includes:

obtaining a communication identifier for the user pre-bound to the target account;

the step of outputting alert information includes:

based on the obtained communication identifier for the user, outputting the alert information.

In an implementation, the communication identifier includes a telephone number and/or an email address.

Corresponding to the embodiment of the method, an embodiment of the present application provides a computer program product. The computer program product is run on a computer, to the computer to perform the method for information reminding according to the embodiment, including:

when it is detected that a transaction record for a target account is generated in a blockchain ledger, obtaining the generated transaction record for the target account as a current transaction record;

comparing the current transaction record with a locally stored transaction record(s) for the target account;

when it is determined that the current transaction record differs from any one of the locally stored transaction records for the target account, determining that a security risk of the target account exists; and

outputting alert information to alert a user of the target account that the security risk of the target account exists.

In the embodiment of the present application, whether a transaction on the target account is a legal transaction may be determined by comparing a record of this transaction on the target account in the blockchain ledger with the locally stored transaction records for the target account, and then whether a security risk of the target account exists may be determined. When the current transaction record differs from any one of the locally stored transaction records for the target account, it may be determined that the security risk of the target account exists, and alert information is output to alert a user of the target account that the security risk of the target account exists, which identifies the security of the account.

In an implementation, the method further includes:

when it is determined that the current transaction record is the same as one of the locally stored transaction records for the target account, determining that the target account is safe; and

outputting the current transaction record to remind the user that a transaction was conducted on the target account.

In an implementation, the method further includes:

periodically or non-periodically obtaining transaction records for the target account from the blockchain ledger; and

outputting the obtained transaction records for the target account to enable the user to view the transaction records for the target account and perform account reconciliation.

In an implementation, after outputting the alert information, the method further includes: outputting prompt information to prompt the user to change an account.

In an implementation, outputting alert information includes:

outputting the alert information in a popup window.

In an implementation, before outputting the alert information, the method further includes:

obtaining a communication identifier for the user pre-bound to the target account;

the step of outputting alert information includes:

based on the obtained communication identifier for the user, outputting the alert information.

In an implementation, the communication identifier includes a telephone number and/or an email address.

It should be noted that the relationship terms herein such as “first”, “second”, and the like are only used for distinguishing one entity or operation from another entity or operation, but do not necessarily require or imply that there is any actual relationship or order between these entities or operations. Moreover, the terms “include”, “comprise” or any other variants thereof are intended to cover non-exclusive inclusions, so that processes, methods, articles or devices comprising a series of elements comprise not only those elements listed but also those not specifically listed or the elements intrinsic to these processes, methods, articles, or devices. Without further limitations, elements defined by the sentences “comprise(s) a . . . ” or “include(s) a . . . ” do not exclude that there are other identical elements in the processes, methods, articles, or devices which include these elements.

All of the embodiments in the description are described in a correlated manner, and identical or similar parts in various embodiments can refer to one another. In addition, the description for each embodiment focuses on the differences from other embodiments. In particular, the system embodiments are described briefly, since they are substantially similar to the embodiment of the method, and the related contents can refer to the description of the embodiment of the method.

The above embodiments are simply preferable embodiments of the present application, and are not intended to limit the scope of protection of the present application. Any modifications, equivalent alternatives, improvements, or the like within the spirit and principle of the present application shall be included within the scope of protection of the present application.

1. A method for information reminding, comprising:
when it is detected that a transaction record for a target account is generated in a blockchain ledger, obtaining the generated transaction record for the target account as a current transaction record;
comparing the current transaction record with a locally stored transaction record(s) for the target account;
when it is determined that the current transaction record differs from any one of the locally stored transaction records for the target account, determining that a security risk of the target account exists; and
outputting alert information to alert a user of the target account that the security risk of the target account exists.

2. The method according to claim 1, further comprising:
when it is determined that the current transaction record is the same as one of the locally stored transaction records for the target account, determining that the target account is safe; and
outputting the current transaction record to remind the user that a transaction was conducted on the target account.

3. The method according to claim 1, further comprising:
periodically or non-periodically obtaining transaction records for the target account from the blockchain ledger; and
outputting the obtained transaction records for the target account to enable the user to view the transaction records for the target account and perform account reconciliation.

4. The method according to claim 1, wherein after outputting the alert information, the method further comprises:
outputting prompt information to prompt the user to change an account.

5. The method according to claim 1, wherein outputting alert information comprises:
outputting the alert information in a popup window.

6. The method according to claim 1, wherein before outputting the alert information, the method further comprises:
obtaining a communication identifier for the user pre-bound to the target account;
the step of outputting alert information comprises:
based on the obtained communication identifier for the user, outputting the alert information.

7. The method according to claim 6, wherein the communication identifier comprises a telephone number and/or an email address.

8-14. (canceled)

15. An electronic device comprising a processor, a communication interface, a memory and a communication bus, wherein the processor, the communication interface and the memory communicate with each other via the communication bus;
the memory is configured for storing a computer program;
the processor is configured for executing the computer program stored on the memory, so as to perform operations of:
when it is detected that a transaction record for a target account is generated in a blockchain ledger, obtaining the generated transaction record for the target account as a current transaction record;
comparing the current transaction record with a locally stored transaction record(s) for the target account;
when it is determined that the current transaction record differs from any one of the locally stored transaction records for the target account, determining that a security risk of the target account exists; and
outputting alert information to alert a user of the target account that the security risk of the target account exists.

16. A non-transitory computer-readable storage medium for storing a computer program thereon, wherein the computer program is executed by a processor to cause the processor to perform the method for information reminding according to claim 1.

17. (canceled)

18. The electronic device according to claim 15, wherein the processor is further caused to perform operations of:
when it is determined that the current transaction record is the same as one of the locally stored transaction records for the target account, determining that the target account is safe; and
outputting the current transaction record to remind the user that a transaction was conducted on the target account.

19. The electronic device according to claim 15, wherein the processor is further caused to perform operations of:
periodically or non-periodically obtaining transaction records for the target account from the blockchain ledger; and
outputting the obtained transaction records for the target account to enable the user to view the transaction records for the target account and perform account reconciliation.

20. The electronic device according to claim 15, wherein, after the alert information is output, the processor is further caused to perform an operation of: outputting prompt information to prompt the user to change an account.

21. The electronic device according to claim 15, wherein the processor is further caused to perform an operation of:
outputting the alert information in a popup window.

22. The electronic device according to claim 15, wherein before the alert information is output, the processor is further caused to perform operations of:
obtaining a communication identifier for the user pre-bound to the target account; and
based on the obtained communication identifier for the user, outputting the alert information.

23. The electronic device according to claim 22, wherein the communication identifier comprises a telephone number and/or an email address.
